(19) United States
(12) Patent Application Publication
(10) Pub. No.: US 2005/0122940 A1
(43) Pub. Date: Jun. 9, 2005

(54) Method for wireless network communication in dual mode

(76) Inventor: Zhi-Heng Nian, San Chong (TW)

Correspondence Address: Raymond Sun, Suite 155, 20 Corporate Park, Irvine, CA, 92606, US

(21) Appl. No.: 10/775,584

(22) Filed: Feb. 9, 2004

(30) Foreign Application Priority Data
Dec. 5, 2003 (TW) 92134444

(51) Int. Cl. H04Q 7/24

(52) U.S. Cl. 370/338

(57) ABSTRACT

A method of communicating in a wireless network with a wireless communicating device of a computer is disclosed. According to the method, a network-setting list is received by the wireless communicating device from the computer, with the network setting list having a list of service set identifiers (SSID). The wireless communicating device then locates a linking request based on an acceptable SSID that is found in the network setting list. Thereafter, the linking request is processed in the ad-hoc mode with a near-end device or in the infrastructure mode with a remote-end device, depending on whether the acceptable SSID is found in the network setting list.

### BACKGROUND OF THE INVENTION

1. Field of the Invention

The present invention relates to a method for wireless network communication, and in particular, to dual mode linking processes by activating an ad-hoc mode and an infrastructure mode simultaneously.

2. Description of the Prior Art

There are two different ways to transmit data or communicate through a network environment. The first way is a wired communication with a cable, and the second way is a wireless communication with an infrared ray, radio frequency or the like. However, due to the convenience in installation and its mobility in use, wireless communication is becoming increasingly popular.

The wireless network can be further classified according to its range of data transmission. Examples include a wireless wide area network (WWAN), a wireless local area network (WLAN), and a wireless personal area network (WPAN). The WLAN is a network which can be transmitted in a range of about hundred meters, and is usually applied in a single building or in an office. In practical use, WLAN will adopt an Access Point to combine with a wired network so as to promote flexibility in use and to enlarge the transmission range. WLAN protocol is now governed by the Institute of Electrical and Electronic Engineers (IEEE), which essentially introduces several wireless communication protocol standards, such as 802.11 serial, HIPERLAN, HOMERF and 1394, etc. Ad-hoc mode and Infrastucture mode are further defined in 802.11 serial. The ad-hoc mode discloses a peer-to-peer (computer to computer, or computer to device) wireless communication, and the infrastructure mode discloses a wireless communication between a wired network and a wireless network via an Access Point.

FIG. 1A illustrates communication in an ad-hoc mode. A wireless communicating device 200 that is coupled to a computer 100 will conduct a wireless data communication with a peripheral device 400 that is located a short distance within a wireless network 10, using the same service set identifier (SSID) and service network channel. FIG. 1B illustrates communication in an infrastructure mode. A wireless communicating device 200 that is coupled to a computer 100 will conduct a wireless data communication with a remote-end sever 350 within a wireless network 10 through an Access Point (AP) 300 of a wired network 20, using the same service set identifier (SSID). Unfortunately, the ad-hoc mode and the infrastructure mode cannot coexist in a wireless communicating device 200 that uses a sole SSID.

Therefore, there still remains a need for a dual mode communication which will enable a computer to link different peripheral devices, or to different computers or servers connected to a wired network.

### SUMMARY OF THE DISCLOSURE

It is an object of the present invention to provide a dual mode communication between a computer and peripheral devices in a wireless network environment.

It is another object of the present invention to allow a computer to simultaneously communicate with a near-end device and a remote-end device.

In order to accomplish the objects of the present invention, the present invention provides a method of communicating in a wireless network with a wireless communicating device of a computer. According to the method, a network-setting list is received by the wireless communicating device from the computer, with the network setting list having a list of service set identifiers (SSID). The wireless communicating device then locates a linking request based on an acceptable SSID that is found in the network setting list. Thereafter, the linking request is processed in the ad-hoc mode with a near-end device or in the infrastructure mode with a remote-end device, depending on whether the acceptable SSID is found in the network setting list.

### BRIEF DESCRIPTION OF THE DRAWINGS

FIG. 1A is a block diagram illustrating communication in an ad-hoc mode.

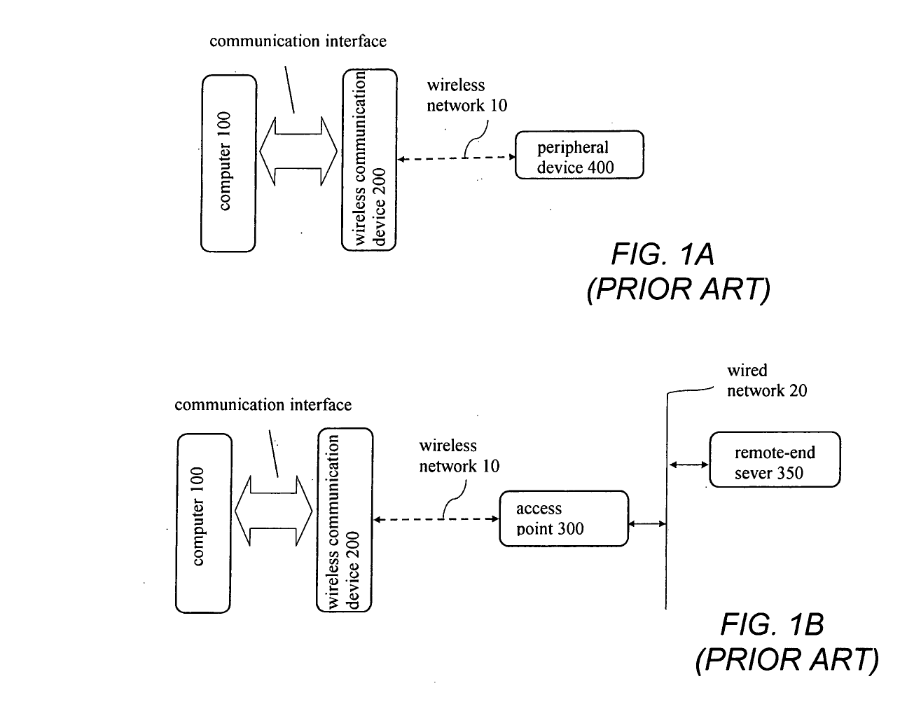

FIG. 1B is a block diagram illustrating communication in an infrastructure mode.

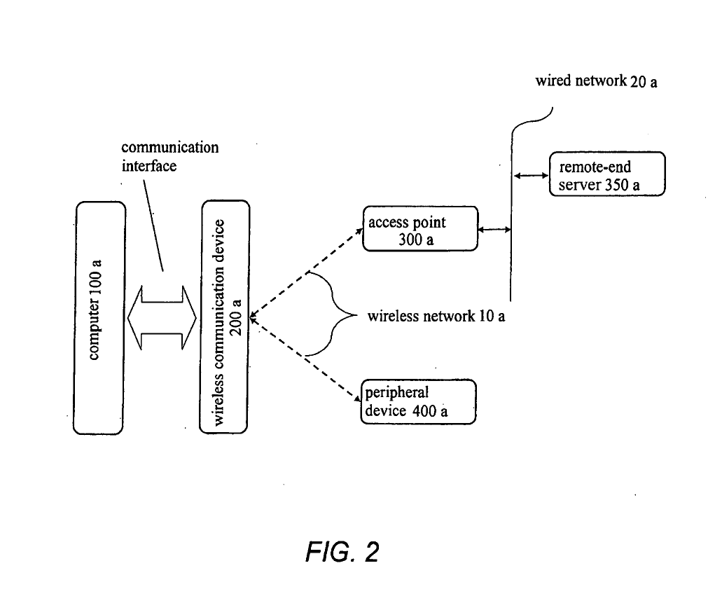

FIG. 2 is a block diagram of a communication system according to one embodiment of the present invention.

FIG. 3A-3B is a flow chart of a communication method according to the present invention.

### DETAILED DESCRIPTION OF THE PREFERRED EMBODIMENTS

The following detailed description is of the best presently contemplated modes of carrying out the invention. This description is not to be taken in a limiting sense, but is made merely for the purpose of illustrating general principles of embodiments of the invention. The scope of the invention is best defined by the appended claims.

The present invention relates to dual mode linking processes by simultaneously activating an ad-hoc mode and an infrastructure mode for receiving a near-end linking request and a remote-end linking request, respectively.

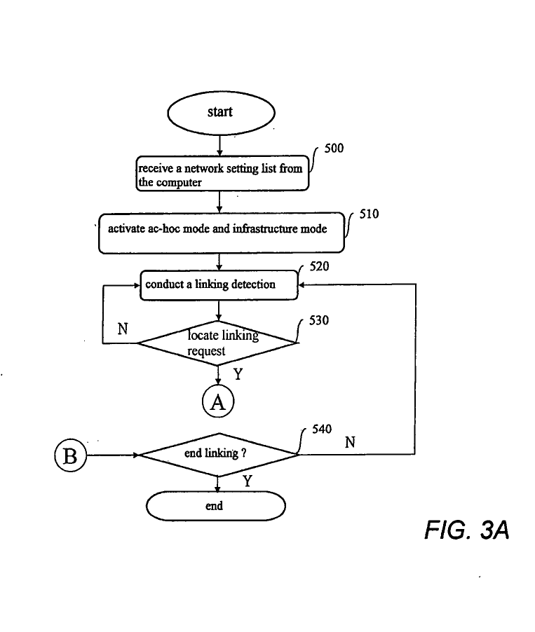

Referring to FIG. 2, a computer 100a is coupled to a wireless communicating device 200a. If the computer 100a wishes to communicate with a peripheral device 400a that is located a short distance within a wireless network 10a (i.e., at a short distance away), the wireless communicating device 200a can communicate in the ad-hoc mode. If the computer 100a wishes to communicate with a server 350a at a remote-end (i.e., at a far-away location), the wireless communicating device 200a can communicate in the infrastructure mode via the access point (AP) 300a of a wired network 20a.

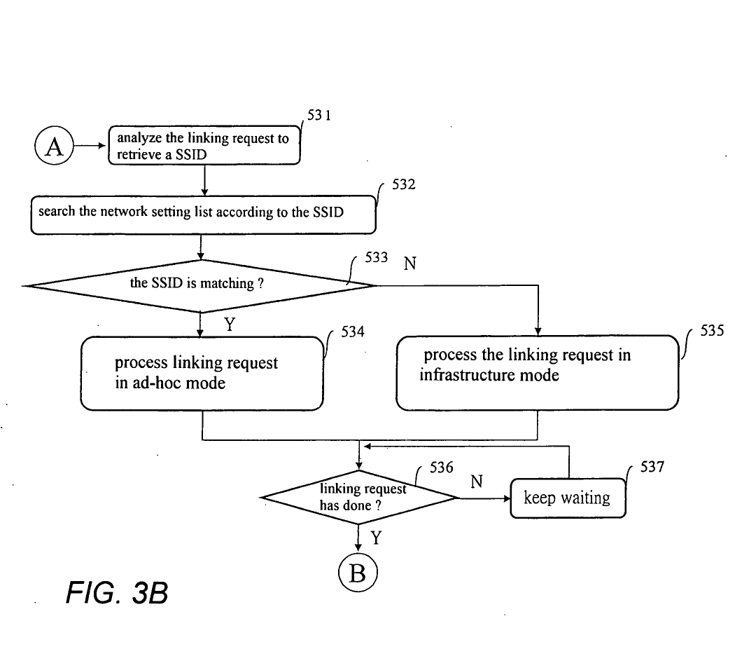

FIGS. 3A-3B illustrate a flow chart for a communication mode that can be used by the system in FIG. 2. When the computer 100a is in the wireless network environment, the wireless communicating device 200a receives a network-setting list from the computer 100a (step 500). The network setting list records some acceptable data relating to the service set identifier (SSID) and the service network channel. The wireless communicating device 200a then initializes a firmware within the communicating device 200a to simultaneously activate the ad-hoc mode and the infrastructure mode (step 510). The firmware is usually stored in a control unit of the communicating device 200a according to techniques known in the art.

The wireless communicating device 200a then conducts a linking detection (step 520) so as to locate a linking request (step 530). In this regard, a linking request is a wireless signal that is generated by the computer 100a, the server 350a or the peripheral device 400a when they wish to establish a wireless connection. This is known as a “linking detection”. The linking request is generated by the computer 100a as a transmitting request, or is received from the server 350a via the AP 300a or the peripheral device 400a as a receiving request, and each linking request also has a specific SSID.

Returning to FIG. 3A, if a linking detection is not established, the wireless communicating device 200a will keep conducting the linking detection (step 520) until a linking detection is established, at which time processing proceeds to step A.

Referring now to FIG. 3B, in step 531, the wireless communicating device 200a will analyze the linking request to retrieve an SSID, and search the network-setting list to see if the SSID from the linking request exists in the network setting list (step 532). If the SSID from the linking request matches one of the SSIDs on the network-setting list (step 533), the wireless communicating device 200a processes the linking request in ad-hoc mode according to the service network channel of the SSID (step 534). On the other hand, if the SSID of the linking request is not on the network-setting list, then the wireless communicating device 200a processes the linking request in the infrastructure mode (step 535).

After either step 534 or 535, the communicating device 200a will determine if the linking request has already been completed (step 536). A linking request is completed when the communication between the communicating device 200a and he peripheral device 400a has been built in either the ad hoc mode or the infrastructure mode. If the linking request has been completed, then processing proceeds to step B to determine if the wireless network linking should be ended (step 540 in FIG. 3A). This decision is made by the communicating device 200a. If the linking request has not been completed, then the method continues to wait until the linking request has been completed (step 537). If the user does not wish to end the linking of the wireless network in step 540, then processing returns to step 520 to conduct the linking detection again.

The wireless communicating device 200a can be a wireless network card which complies with a standard wireless network communication protocol, such as the 802.11 serial, but is not limited to that which is enacted by the Institute of Electrical and Electronic Engineers (IEEE). In addition, the peripheral device 400a can be a computer mouse, trackball, keyboard, joystick, tablet, touch pad, game controller, scanner, printer, or other similar device.

While the description above refers to particular embodiments of the present invention, it will be understood that many modifications may be made without departing from the spirit thereof. The accompanying claims are intended to cover such modifications as would fall within the true scope and spirit of the present invention.

1. A method of communicating in a wireless network which includes a computer, a wireless communicating device and a peripheral device, comprising:
a) providing the wireless communicating device with a network-setting list that has a list of service set identifiers (SSID);
b) conducting a linking detection so as to locate a linking request from the computer or the peripheral device, each linking request having a specific SSID; and
c) processing the linking request in ad-hoc mode if the specific SSID matches one of the SSIDs in the network-setting list, and processing the linking request in infrastructure mode if the specific SSID does nor match one of the SSIDs in the network-setting list.

2. The method as claimed in claim 1, further including:
the wireless communicating device activates the ad-hoc mode and the infrastructure mode.

3. The method as claimed in claim 1, wherein the wireless communicating device is a wireless network card which complies with a standard wireless network communication protocol.

4. The method as claimed in claim 2, further including intializing a firmware in the wireless communicating device to activate the ad-hoc mode and the infrastructure mode.

5. The method as claimed in claim 1, wherein the linking request includes a transmitting request or a receiving request.

6. The method as claimed in claim 1, wherein the peripheral device is selected from the group consisted of computer mouse, trackball, keyboard, joystick, tablet, touch pad, game controller, scanner and printer.

7. The method as claimed in claim 1, wherein the computer provides the wireless communicating device with the network-setting list.

8. The method as claimed in claim 1, wherein the wireless network further includes a remote server, and wherein step (b) further includes:
conducting a linking detection so as to locate a linking request from the server, the computer or the peripheral device, each linking request having a specific SSID.

9. A method of communicating in a wireless network with a wireless communicating device of a computer, the method comprising:
receiving a network-setting list from the computer, the network setting list having a list of service set identifiers (SSID);
the wireless communicating device locating a linking request based on an acceptable SSID that is found in the network setting list; and
processing the linking request in the ad-hoc mode with a near-end device or in the infrastructure mode with a remote-end device, depending on whether the acceptable SSID is found in the network setting list.

10. The method as claimed in claim 9, further including:
the wireless communicating device activates the ad-hoc mode and the infrastructure mode.

11. The method as claimed in claim 9, wherein the wireless communicating device is a wireless network card which complies with a standard wireless network communication protocol.

12. The method as claimed in claim 10, further including intializing a firmware in the wireless communicating device to activate the ac-hoc mode and the infrastructure mode.

13. The method as claimed in claim 9, wherein the linking request includes a transmitting request or a receiving request.

14. The method as claimed in claim 9, wherein the peripheral device is selected from the group consisted of computer mouse, trackball, keyboard, joystick, tablet, touch pad, game controller, scanner and printer.
